(19) United States
(12) Patent Application Publication
(10) Pub. No.: US 2008/0179066 A1
(43) Pub. Date: Jul. 31, 2008

(54) Mounted fire suppression system

(76) Inventors: Randal F. Sisk, Winnsboro, SC (US); Randy L. Bradwell, Winnsboro, SC (US)

Correspondence Address: Randy L. Bradwell, 125 Pine Street, Winnsboro, SC, 29180, US

(21) Appl. No.: 11/407,471

(22) Filed: Apr. 20, 2006

(51) Int. Cl. A62C 3/07

(52) U.S. Cl. 169/46; 169/62

(57) ABSTRACT

This invention is intended to be a mounted fire extinguishing system for all types of vehicles, but generally in areas such as brake shoe/wheel seal, engine compartment or other areas of high heat and friction. The system has a metal tank (1) mounted to the vehicle's chassis, a “T” valve (4) attached to the top of the tank with an air gauge (5), an air filler valve (6) attached for the refilling and re-pressurizing of system, two gated valves (8) allowing the fire extinguishing material to flow through flexible hoses (9, 10) to the sprinkler heads (16, 17, 18, 19) pointed at the fire area or to the nozzle for spraying adjacent areas. The mounted fire extinguishing system is designed to allow the operator to direct the fire extinguishing material to the location most likely to have fires while being a safe distance from the source of the fire.

### STATEMENT REGARDING FEDERALLY SPONSORED RESEARCH OR DEVELOPMENT

This invention is not federally sponsored or developed.

### REFERENCE TO SEQUENCE LISTING, A TABLE, OR A COMPUTER PROGRAM LISTING COMPACT DISC APPENDIX

No material will be submitted on compact disc.

### BACKGROUND OF THE INVENTION

The present invention generally relates to fire suppression systems, and, in particular, relates to water based/foam fire suppression systems intended to be installed to the brake shoe/wheel seal section of a motorized or pulled vehicle. This invention will be fitted to include a variety of vehicles including, but not limited to, tractor-trailer, heavy-duty commercial trucks or light-duty (straight) trucks, trailers of all kinds, aircraft, and marine vessels.

It is generally known that there are no fire suppression systems located in the brake shoe/wheel seal section of a vehicle. It is also generally known that fires ignited in the wheel and/or brake area of the vehicle tend to cause damage due to its proximity to the tires causing melting. Furthermore, the length of time required to discover the fire, stop the progress of the vehicle and extinguish the fire using prior art can cause additional damage. This extended period of time between sensing and extinguishing can allow the fire to spread to other areas of the vehicles causing damage to human life, cargo and other vehicles.

This invention is designed to sense and extinguish fires, related to heat, friction and other specific causes, in areas of vehicles that are obscured from site while the vehicle is in use. This invention would allow any fire to be contained immediately while simultaneously allowing the operator of the vehicle to safely stop the vehicle.

Prior art consist of non-mounted extinguishing systems which require a human to come is close proximity to the fire in order to fight the fire. In addition, valuable time is lost searching for non-mounted extinguishers or poorly maintained systems. Typical fire extinguishers can be lost, stolen or lose their charge because they are not considered a vital component of the vehicle.

It can be seen in the construction industry that the installation of ceiling mounted sprinkler systems will greatly increase the likelihood that a fire will be extinguished before significant damage is done to areas surrounding the immediate area. This is evidenced by their mandatory inclusion in fire codes of commercial and residential building around the world.

One example of prior art includes a canister filled with pressurized Halon. Such Halon systems are no longer desirable for fire suppression. Additionally, any chemical fire suppressant pressurized within a canister includes disadvantages similar to the ones listed below.

One disadvantage of a pressurized chemical fire suppression system is that once it has been discharged; the canister containing the pressurized chemical must be replaced. These systems do not allow easy recharging of the pressurized chemical to reuse the system since they must be sent to the commercial recharging service for recharging. In addition, other portions of the system, including the nozzles and lines, may also need to be replaced after only one discharge of the fire suppression system.

The chemical itself poses a risk to the health of humans and animals as well as to the environment. The chemical becomes undesirable because it emits such chemicals into the atmosphere. Some chemicals have been banned due to ozone depletion.

Therefore, it has become highly desirable to use a fire suppression system that does not emit undesirable chemicals into the environment.

It would also be desirable to provide a fire suppression system that facilitates easy identification of whether the fire suppression system has been activated. Furthermore, it would be helpful if the system allowed a maintenance person to easily identify whether the system must be recharged or serviced.

It would be a further advantage to provide a fire suppression system, which could be installed under the cargo section of a truck without requiring significant structural modifications to the truck.

Still further, it would be desirable to provide a fire suppression system for any truck, which does not require extensive machining and creation of new parts for the fire suppression system.

It would also be a great advantage to provide a fire suppression system with a hose that may be moved about to extinguish any fires on the vehicle or on adjacent vehicles.

The present invention includes a fire suppression system especially well suited for the transportation industry. The present invention may also be readily adapted for fire suppression at any location on the vehicle.

In a preferred embodiment, the present invention includes four spray nozzles that are directed to the brake shoes/wheel seal area on these vehicles, thereby releasing a mixture of water/foam from a reservoir on the vehicle. the present invention would include sensors that sense heat and or, flame and which activate the system releasing water/foam from a reservoir on the vehicle.

In view of the above stated problems, it would be extremely beneficial to have a potentially life and material saving device that can both manually and automatically extinguish fires without a human coming in close contact. Furthermore, the ability to extinguish a fire while the operator safely brings the vehicle to a stop will alleviate the likelihood of causing harm to others around the vehicle via collisions or spreading of the fire.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Variations that do not depart from the gist of the invention are intended to be within the scope of the invention. Such variations are not to be regarded as a departure from the spirit and scope of the invention.

### BRIEF SUMMARY OF THE INVENTION

The present invention is a fire extinguishing system designed to be installed on the underside of vehicles (as generally described above) in order to sense and extinguish fires located in the brake shoe/wheel seal section of vehicles. Such a device will allow faster discovery of fires and therefore, more quickly extinguish fires that inevitably cause more damage.

The device is comprised of an oblong, metal tank which is rechargeable that is attached to the underside of the vehicle. There are hoses attached to four sprinkler heads that will disperse the water based/foam extinguishing agent directly at the site of the fire. The tank, hoses, sprayer heads and additional parts are easily accessible for periodic inspection and replacement if needed. The hoses and sprayer heads are also available to be redirected to extinguish fires in adjacent locations on the vehicle or on other vehicles.

A feature of the device is its simplistic design, installation and maintenance. Because of its straightforward design, the device is easily inspected and available for upkeep by general mechanics during normal maintenance of the vehicle. The tank can be transferred from one vehicle to another with little effort. Additionally, the operator or general mechanic can refill the tank by adding additional fire extinguishing material that comes with the system.

Another feature of this invention is that it is widely adaptable to fit most any vehicle without major expense for retrofit, long out of service time for the vehicle for installation and can be installed by general mechanics after training has been completed.

This invention also employs a water based/foam type extinguishing agent that is not found to be harmful to humans, animals or the environment. Prior devices have contained chemicals banned due to ozone depletion or other harmful effects on the environment.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE SEVERAL VIEWS OF THE DRAWINGS

The present invention will become more fully understood from the detailed description and the accompanying drawings, wherein:

DRAWING 1 is a perspective drawing of the oblong, metal tank according to the embodiment of the present invention.

DRAWING 2 is a more detailed perspective drawing of the tank showing the input valve (air filler valve) as used for recharging the tank and the discharge valve allowing the release of the water based/foam extinguishing agent into the hoses and subsequently into the sprayer heads.

DRAWING 3 is an exploded view of the input valve and associated air gauge used for accurate filling levels.

DRAWING 4 is a side view of the discharge valve and the connection to the hose leading to the sprinkler heads and the hose maintained to extinguish fires manually. The length is shown as 50 feet, but can be shortened for proper retrofit to vehicle.

DRAWING 5 is a perspective drawing of the hose running from the discharge valve of the tank to the sprinkler heads mounted to the manifold/chassis of the vehicle.

### DETAILED DESCRIPTION OF THE INVENTION

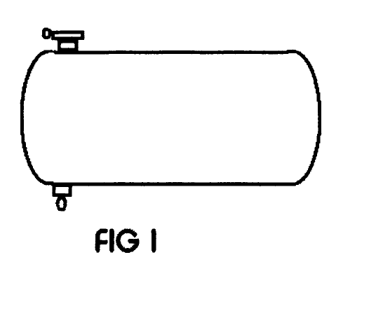

Referring to Drawings 2 and 5, the key components of the Mounted Fire Suppression System are shown. In the representations shown, the Mounted Fire Suppression System has a metal tank (FIG. 1) that attaches to the underside of the vehicle that preferably has an adjustable bracket permanently attached along the centerline. The tank would be affixed to the vehicle's chassis in a variety of methods as decided at the time of installation by the bracket.

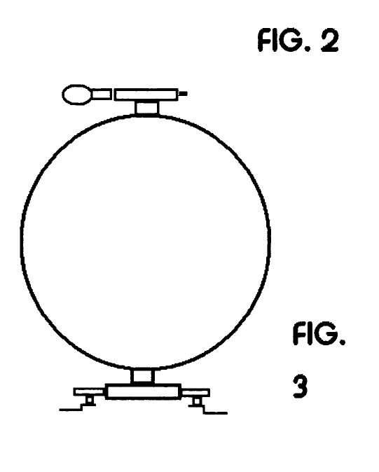

Referring to Drawing 2, the metal tank has two threaded openings at the top and bottom of the tank that will allow for input of extinguishing material and water as well as dispersion of materials from tank. The threaded opening intended for input of the extinguishing material will have a Department of Transportation approved air gauge and commonly found air filler valve (FIG. 2). The threaded opening intended for dispersion of extinguishing material will have two commonly found gated valves made of any material that is able to withstand the forces associated with the valves being rapidly opened and closed during use (FIG. 3).

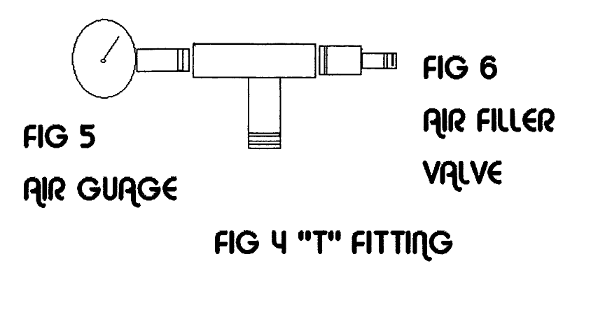

Drawing 3 shows the detailed view of the apparatus used to pressurize the metal tank (FIG. 1) during regular maintenance or installation. A commonly found threaded, metallic or semi-metallic “T” valve (FIG. 4) with a threaded male end is attached to the metal tank (FIG. 1) via the female threaded opening at the top of the tank. A US Department of Transportation approved air gauge (FIG. 5) is secured to one end of the “T” valve (FIG. 4) via one of the threaded ends. The air gauge (FIG. 5) is vital to this system to allow proper pressurization of the metal tank (FIG. 1) once the correct amount of water and extinguishing material is added. Accurate pressurization is critical to the system working at its maximum effectiveness. An air filler valve (FIG. 6) is inserted and secured into the “T” valve (FIG. 4) via the threaded male part of the air filler valve (FIG. 6). The air filler valve (FIG. 6) is used by the Mounted Fire Suppression System to allow air to pressurize the metal tank (FIG. 1) which contains the water based/foam type-extinguishing agent.

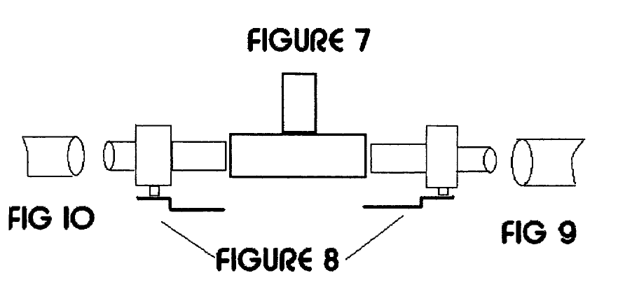

Drawing 4 illustrates the detailed view of the apparatus used to discharge the metal tank. As in Drawing 3, the discharge section is connected to the tank via a commonly found, metallic or semi-metallic “T” fitting (FIG. 7) with a threaded male end and tightened into the threaded, female opening in the tank. Two commonly found gated valves (FIG. 8), made of any material that is able to withstand the forces associated with the valves being rapidly opened and closed during use, are attached to either end of the “T” fitting (FIG. 7). The gated valves are attached to the “T” fitting by a variety of commonly used means depending on the material type of the “T” fitting and gated valves.

One of the gated valves (FIG. 8), is attached to a hose (FIG. 9) that can be constructed of rubber, plastic, polymer or any other material that will be able to withstand the stresses associated with its proximity to heat and fire and exposure to the natural elements. This hose is cut to the required length necessary to traverse the distance from the tank to the sprinkler heads located in the brake shoe/wheel seal section of the vehicle.

The other gated valve (FIG. 8), is attached to a hose (FIG. 10) that can be constructed of rubber, plastic, polymer or any other material that will be able to withstand the stresses associated with its proximity to heat and fire and exposure to the natural elements. This hose will be approximately 50 feet in length and attached to a nozzle that can be used to extinguish fires in adjacent locations to the vehicle.

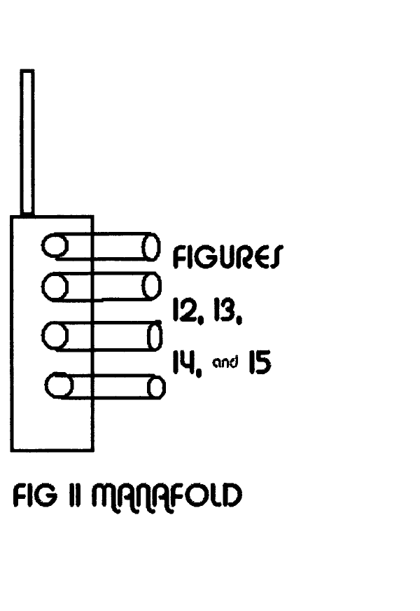

Drawing 5 represents the layout of the sprinkler heads attached to the hose coming from the metal take. This hose carries the extinguishing material from the tank and disperses it at the point of the fire through the sprinkler heads (FIGS. 16, 17, 18 and 19). The hose (FIG. 9) coming from the tank is attached to a metal manifold (FIG. 11) via a variety of generally accepted methods. The manifold (FIG. 11) is attached to the vehicle's chassis via threaded bolts. This attachment is described generically as to allow maximum flexibility at the time of installation to meet the needs of the vehicle.

There are 4 hoses (FIGS. 12, 13, 14 and 15), that connect the manifold (FIG. 11) directly to the sprinkler heads (FIGS. 16, 17, 18 and 19). The hoses can be constructed of rubber, plastic, polymer or any other material that will be able to withstand the stresses associated with its proximity to heat and fire and exposure to the natural elements. The length of the hoses is determined by the installation needs of the vehicle.

The sprinkler heads (FIGS. 16, 17, 18 and 19) are affixed to the chassis such that they are directed towards the brake shoe/wheel seal section of the vehicle. A variety of common accepted methods of attachment will be used as situations arise. It would be preferred to have the sprinkler heads affixed to the chassis directly using threaded bolts; however, the installation may require that a special bracket or other type of extensions be added so that the sprinkler heads are in the best proximity to the brake shoe/wheel seal section of the vehicle.

The fabrication of the Mounted Fire Suppression System of the present invention is not limited to design and/or the materials described or as shown herein. In this regard, those skilled in the art will find that the Mounted Fire Suppression System can be designed and its function can be accomplished in a variety of similar ways. Additionally, those skilled in the art will see that many substitutions and modifications to the foregoing preferred embodiments are possible without departing from the spirit and scope of the preferred embodiments.

Therefore, while the referred embodiments and the best mode of the present invention are described herein, it should be understood that the best mode for carrying out the invention herein described is by way of illustration and not by way of limitation. It is intended that the scope of the present invention included all modifications that incorporate its principal design features, and that the scope and limitations of the present invention are to be determined by the scope of the appended claims and their equivalents.

LIST OF REFERENCE NUMBERS

| | |
|---|---|
| Metal tank | 1 |
| “T” Fitting | 4 |
| Air Gauge | 5 |
| Air Filler Valve | 6 |
| “T” Fitting | 7 |
| Gated Valves | 8 |
| Hose | 9 |
| Hose | 10 |
| Manifold | 11 |
| Sprinkler Hoses | 12 |
| Sprinkler Hoses | 13 |
| Sprinkler Hoses | 14 |
| Sprinkler Hoses | 15 |
| Sprinkler Heads | 16 |
| Sprinkler Heads | 17 |
| Sprinkler Heads | 18 |
| Sprinkler Heads | 19 |

What is claimed is:

1. A mounted fire suppression system for use in sensing and extinguishing fires, related to heat, friction and other specific causes, in areas of vehicles that are obscured from site while the vehicle is in use, comprising of:
a metal tank that has two threaded openings—one on the top for filling and one on the bottom for discharge;
a mounting bracket attached to the metal tank comprising of a track whereby the tank is adjustable for mounting to the vehicle in a variety of methods.

2. The apparatus in claim 1, further comprising of a standard “T” type valve secured to the top threaded opening of the tank allowing the addition of an air gauge and an air filler valve.

3. The apparatus in claim 1, further comprising of a standard “T” type valve secured to the bottom threaded opening of the tank allowing the addition of two gated valves on opposite sides of the “T” valve.

4. The apparatus in claim 3, wherein one of the said gated valves allows and disallows the flow of fire extinguishing material from the tank into a flexible hose.

5. The apparatus in claim 4, wherein said flexible hose leads to a manifold apparatus attached by threaded bolts to the chassis of the vehicle; further, the manifold allows for the splitting of the fire extinguishing material into four flexible hoses.

6. The apparatus in claim 5, wherein said four flexible hoses each have a sprinkler head attached to the end allowing the fire extinguishing material to be directed at the source of the fire.

7. The other gated valve described in claim 3 allows and disallows the flow of fire extinguishing material from the tank into a flexible hose having a nozzle attached to the end for the manual direction of fire extinguishing materials to other areas of the vehicle or adjacent objects.

8. The apparatus in claim 7, wherein said flexible hose and nozzle are affixed to the vehicle by a variety of methods as desired by the owner and as regulated by federal, state and local authorities.

9. Said mounted fire suppression system can have an additional feature whereby a heat sensing device is affixed near the brake shoe/wheel seal section of a vehicle whereby the system will be automatically alerted to begin dispensing fire extinguishing material.

10. Said mounted fire suppression system can have an additional feature whereby a mechanism is located within reach of the driver or otherwise located further away from the tank for remote operation of the gated valves.

11. Said mounted fire suppression system is designed to allow refill of said tank with appropriate mix of water and fire extinguishing material, while pressurized with air as instructed

12. A method of using a mounted fire suppression system comprises of the steps of:
heat sensing detectors may be mounted to notify the operator of the vehicle that an actual fire or an impending fire is existing on the vehicle;
the operator or bystander can approach the tank affixed to the vehicle and open the gated valve leading to the manifold which will allow fire extinguishing material to flow from the tank through the flexible hose to the sprinkler heads and extinguish the fire;
additionally, the operator or bystander can open the gated valve allowing fire extinguishing material to flow through the flexible hose leading to the nozzle whereby the operator can point the nozzle towards a fire located in adjacent areas of the vehicle;
the tank is located on the vehicle such that the valves can be opened while the operator can be a safe distance from the most likely location of the origination point of a fire.
